(19) United States
(12) Patent Application Publication
(10) Pub. No.: US 2025/0390458 A1
(43) Pub. Date: Dec. 25, 2025

(54) DUAL-SIDED MEMORY DEVICE AND ASSOCIATED SYSTEMS AND METHODS

(71) Applicant: Micron Technology, Inc., Boise, ID (US)

(72) Inventor: Sujeet Ayyapureddi, Boise, ID (US)

(21) Appl. No.: 19/239,066

(22) Filed: Jun. 16, 2025

Related U.S. Application Data
(60) Provisional application No. 63/663,607, filed on Jun. 24, 2024.

(51) Int. Cl. G06F 13/42; G06F 13/16

(52) U.S. Cl. CPC G06F 13/4221; G06F 13/1663

(57) ABSTRACT

System-in-Package (SiP) devices and associated systems and methods are disclosed herein. In some embodiments, a SiP device includes a high-bandwidth memory (HBM) device communicably coupled to a plurality of host devices. The HBM device is communicably coupled to the plurality of host devices via a plurality of correlated input/output (IO) circuits. Each of the plurality of IO circuits is disposed on a different side of an interface die of the HBM device. Each of the plurality of IO circuits can be configured to operate according to standards and protocols appropriate for the correlated host device. The HBM device further includes multiple pluralities of through-substrate vias (TSVs), of which each plurality of TSVs is correlated with one of the plurality of host devices. A memory of the HBM device can be partitioned such that each of the memory partitions is accessible by one of the plurality of host devices.

### CROSS-REFERENCE TO RELATED APPLICATION(S)

The present application claims priority to U.S. Provisional Patent Application No. 63/663,607, filed Jun. 24, 2024, the disclosure of which is incorporated herein by reference in its entirety.

### TECHNICAL FIELD

The present technology is generally related to vertically stacked semiconductor memory devices, and more specifically to systems and methods for high-bandwidth memory devices with base dies having input/output interfaces on two sides of the base dies.

### BACKGROUND

An electronic apparatus (e.g., a processor, a memory device, a memory system, or a combination thereof) can include one or more semiconductor circuits configured to store and/or process information. For example, the apparatus can include a memory device, such as a volatile memory device, a non-volatile memory device, or a combination device. Memory devices, such as dynamic random-access memory (DRAM) and/or high-bandwidth memory (HBM), can utilize electrical energy to store and access data.

With technological advancements in embedded systems and increasing applications, the market is continuously looking for faster, more efficient, and smaller devices. To meet market demands, semiconductor devices are being pushed to the limit with various improvements. Improving devices, generally, may include increasing circuit density, increasing circuit capacity, increasing operating speeds (or otherwise reducing operational latency), increasing reliability, increasing data retention, reducing power consumption, or reducing manufacturing costs, among other metrics. Attempts, however, to meet market demands, such as increasing or maintaining bandwidth with a variety of architectures, can often introduce challenges in other aspects, such as maintaining circuit robustness and/or mitigating heat generation.

### BRIEF DESCRIPTION OF THE DRAWINGS

FIG. 1 is a partially schematic cross-sectional diagram of a system-in-package device.

FIG. 2 is a partially schematic top-down view of a system-in-package device configured in accordance with some embodiments of the present technology.

FIG. 3 is a partially schematic cross-sectional diagram of a system-in-package device configured in accordance with some embodiments of the present technology.

FIG. 4 is a partially schematic top-down view of a system-in-package device configured in accordance with further embodiments of the present technology.

FIG. 5 is a flow diagram of a process for manufacturing a system-in-package device in accordance with some embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

High data reliability, high speed of memory access, lower power consumption, and reduced chip size are features that are demanded from semiconductor memory. In recent years, vertically stacked memory devices have been introduced, often referred to as 2.5-dimensional (“2.5D”) memory devices when placed adjacent to a host device. Some 2.5D memory devices are formed by stacking memory dies vertically, and interconnecting the dies using through-silicon (or through-substrate) vias (TSVs). Benefits of the 2.5D memory devices include shorter interconnects (which reduce circuit delays and power consumption), a large number of vertical vias between layers (which allow wide bandwidth buses between functional blocks, such as memory dies, in different layers), and a considerably smaller footprint. Thus, the 2.5D memory devices contribute to higher memory access speed, lower power consumption, and chip size reduction. Example 2.5D memory devices include Hybrid Memory Cube (HMC) and High-Bandwidth Memory (HBM) devices. For example, HBM devices are a type of memory that includes a vertical stack of dynamic random-access memory (DRAM) dies and an interface die (which, e.g., provides the interface between the DRAM dies of the HBM device and a host device).

In a system-in-package (SiP) configuration, HBM devices may be integrated with host devices (e.g., one or more graphics processing units (GPUs), computer processing units (CPUs), tensor processing units (TCUs), and/or any other suitable processing units) using a base substrate (e.g., a silicon interposer, a substrate of organic material, a substrate of inorganic material and/or any other suitable material that provides interconnection between the host device and the HBM device and/or provides mechanical support for the components of a SiP device), through which the HBM devices and hosts communicate. Because traffic between the HBM devices and host devices resides within the SiP (e.g., using signals routed through the silicon interposer), a higher bandwidth may be achieved between the HBM devices and host devices than in conventional systems. In other words, the TSVs interconnecting DRAM dies within an HBM device, and the silicon interposer integrating HBM devices and host devices, enable the routing of a greater number of signals (e.g., wider data buses) than is typically found between packaged memory devices and a host device (e.g., through a printed circuit board (PCB)). The high-bandwidth interface within a SiP enables large amounts of data to move quickly between the host devices (e.g., GPUs/CPUs/TCUs) and HBM devices during operation. For example, the high-bandwidth channels can be on the order of 1000 gigabytes per second (GB/s, sometimes also referred to as gigabits (Gb)). As a result, the SiP device can quickly complete computing operations once data is loaded into the HBM devices. SiP devices, in turn, are typically integrated with a package substrate (e.g., a PCB) adjacent to other electronics and/or other SiP devices within a packaged system.

Market demands on SiP devices and/or the HBM devices therein can present certain challenges, however. One such challenge is that demands on SiP devices (and the HBM devices therein) require the devices to continually increase in functionality while decreasing in package size, thereby increasing power density within the SiP device. As a result, as discussed in more detail below, traffic-heavy circuits in the HBM devices, such as input/output (“IO”) circuits in an interface die (also referred to as a base die), can generate significant amounts of heat. If not mitigated, the heat can cause various deleterious effects on the HBM device, such as the degradation of communication channels, increased memory loss (requiring increased refresh rates and therefore more power), and/or the like. Another such challenge is the introduction of new SiP device architectures that tend to emphasize the use of multiple host devices operating on the SiP device (e.g., in a grid structure). In such architectures each of the host devices typically requires a significant amount of memory bandwidth from HBM devices of the SiP device. Current HBM devices source data from just one side of the device, which can create various challenges when satisfying the memory bandwidth needs of the host devices in the new SiP device architecture (e.g., longer route lengths between a host device and HBM device, more routes within the interposer, a greater number of HBM devices). The systems and methods described herein address these and other challenges posed by new SiP device architectures with HBM devices configured to communicate with one or more host devices using IO interfaces (otherwise referred to as IO circuits) disposed on at least two sides of the HBM devices. For example, a dual-sided HBM device as described herein includes an interface die in which data transferring components (e.g., IO circuits) are disposed on at least two sides of the interface die. As described herein, the dual-sided HBM device can reduce localized hot spots by spreading heat-generating IO circuits on both ends of the interface die, can reduce the route length between the dual-sided HBM device and host devices (thereby improving signaling frequency), can reduce the number of routes in an interposer of the SiP device (thereby reducing interposer costs), and provide various other advantages.

As used herein, the terms “vertical,” “lateral,” “upper,” “lower,” “top,” and “bottom” can refer to relative directions or positions of features in the devices in view of the orientation shown in the drawings. For example, “bottom” can refer to a feature positioned closer to the bottom of a page than another feature. These terms, however, should be construed broadly to include devices having other orientations, such as inverted or inclined orientations where top/bottom, over/under, above/below, up/down, and left/right can be interchanged depending on the orientation.

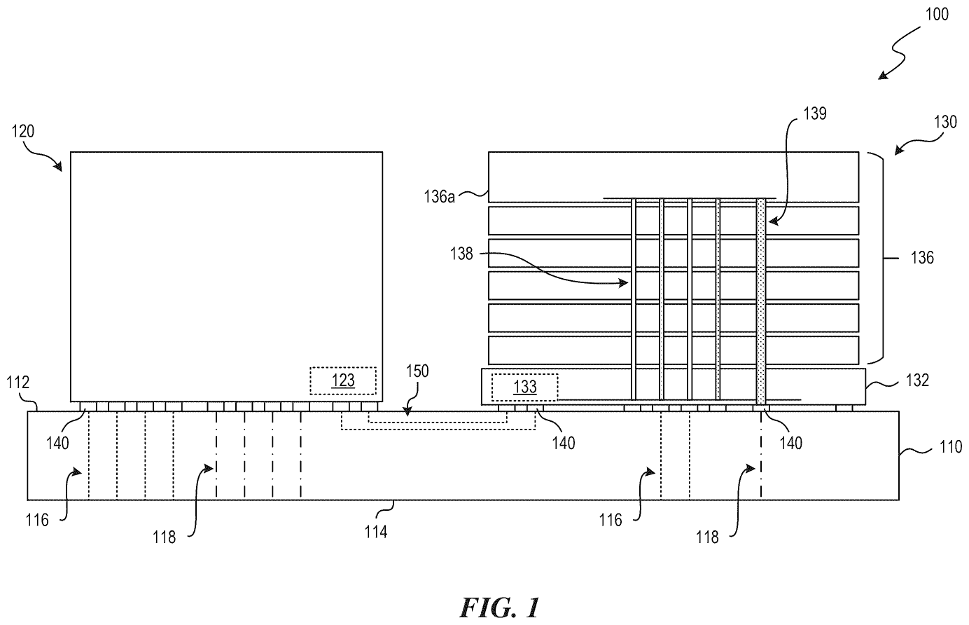

FIG. 1 is a partially schematic cross-sectional diagram of a system-in-package (SiP) device 100. As illustrated in FIG. 1, the SiP device 100 includes a base substrate 110 (e.g., a silicon interposer, another organic interposer, an inorganic interposer, and/or any other suitable base substrate), as well as a host device 120 and an HBM device 130 each integrated with (e.g., carried by and coupled to) an upper surface 112 of the base substrate 110 through a plurality of interconnect structures 140 (three labeled in FIG. 1). The interconnect structures 140 can be solder structures (e.g., solder balls), metal-metal bonds, and/or any other suitable conductive structure that mechanically and electrically couples the base substrate 110 to each of the host device 120 and the HBM device 130. Further, the host device 120 is coupled to the HBM device 130 through one or more communication channels 150 formed in the base substrate 110 (sometimes referred to as a SiP bus). The communication channels 150 can include one or more route lines (two illustrated schematically in FIG. 1) formed into (or on) the base substrate 110.

As further illustrated in FIG. 1, the base substrate 110 includes a plurality of external signal TSVs 116 and a plurality of external power TSVs 118 extending between the upper surface 112 and a lower surface 114 of the base substrate 110. The external signal TSVs 116 can communicate signals (e.g., data, control signals, processing commands, and/or the like) between the host device 120 and/or the HBM device 130 and an external component (e.g., a PCB the base substrate 110 is integrated with, an external controller, and/or the like). The external power TSVs 118 provide electrical power to the host device 120 and/or the HBM device 130 from an external power source.

The host device 120 can include a variety of components, such as a processing unit (e.g., CPU/GPU/TCU), one or more registers, one or more cache memories, and/or a variety of other components. For example, in the illustrated environment, the host device 120 includes a host IO circuit 123 that can direct signals to and/or from the HBM device 130 through the communication channels 150. Additionally, or alternatively, the host IO circuit 123 can direct signals to and/or from an external component (e.g., a controller coupled to one or more of the external signal TSVs 116 and/or the like).

The HBM device 130 can include an interface die 132 and a stack of one or more memory dies 136 (six illustrated in FIG. 1) carried by the interface die 132. The HBM device 130 also includes one or more signal TSVs 138 (four illustrated in FIG. 1) and one or more power TSVs 139 (one illustrated in FIG. 1) each extending from the interface die 132 to an uppermost memory die 136a. The power TSV(s) 139 provide power (e.g., received from one or more of the external power TSVs 118) to the interface die 132 and each of the memory dies 136. The signal TSVs 138 communicably couple each of the memory dies 136 to an IO circuit 133 in the interface die 132 (in addition to various other circuits in the interface die 132). In turn, the IO circuit 133 can direct signals to and/or from the host device 120 and/or an external component (e.g., an external storage device coupled to one or more of the external signal TSVs 116 and/or the like). As illustrated in FIG. 1, the HBM device 130 includes a single IO circuit 133 disposed on a single side of the interface die 132, which, as described above, can lead to various shortcomings (e.g., localized heat spots on the interface die 132, longer routes of communication channels 150 to reach host devices (not shown) disposed on the opposite side of the HBM device, etc.).

Dual-sided HBM devices and related systems and methods that address the shortcomings discussed above are disclosed herein. For example, as discussed in more detail below, a SiP device according to the present technology can include a base substrate, as well as a dual-sided HBM device integrated with the base substrate and two or more host devices for use with the dual-sided HBM device. The dual-sided HBM device can include a stack of one or more memory dies and an interface die having IO circuits disposed on multiple sides of the interface die. For example, the dual-sided HBM device can be communicatively coupled to a first host device on a first side of the HBM device via an IO circuit disposed on the first side of the interface die, and can be communicatively coupled to a second host device on a second side of the dual-sided HBM device via an IO circuit disposed on the second side of the interface die. In other words, host devices may be communicatively coupled to the dual-sided HBM device via IO circuits disposed on sides of the dual-sided HBM device nearest the coupled host devices. In some embodiments the first side and second side (in which the first IO circuit and second IO circuit are disposed, respectively) are opposite sides of the interface die. In some embodiments, the IO circuits of the dual-sided HBM device are not disposed on the sides nearest the host devices used to communicate with those devices. By disposing IO circuits on different sides of the interface die of the dual-sided HBM device, heat generated by the IO circuits is better distributed across the sides the interface die, avoiding localized heat spots. Furthermore, disposing IO circuits on different sides of the interface die opens up degrees of freedom in system design by enabling multiple host devices (e.g., GPUs/CPUs/TCUs) to access the dual-sided HBM device. That is, as described herein, a dual-sided HBM device (e.g., with two IO circuits) may be used by two host devices. Additionally, disposing IO circuits on the nearest side of the interface die relative to the location of the host device to which the IO circuits are connected reduces IO circuit length, improving signaling frequency and integrity.

As also discussed in more detail below, in some embodiments, the dual-sided HBM device can also include two sets of through substrate vias (TSVs) extending through the memory dies and coupled to the IO circuits of the interface die. For example, a first plurality of TSVs can extend through the memory dies and couple to a first IO circuit of a first side of the interface die, and a second plurality of TSVs can extend through the memory dies and couple to a second IO circuit of a second side of the interface die. As discussed in more detail below, the first plurality of TSVs coupled to the first IO circuit can be used to respond to host device requests and access memory of the dual-sided HBM device independently and/or concurrently from the second plurality of TSVs coupled to the second IO circuit, and vice versa. As a result, the dual-sided HBM device can be used concurrently by multiple host devices (e.g., a first host device and second host device). In some embodiments, the memory of the dual-sided HBM device is partitioned such that the first plurality of TSVs is communicatively coupled to a first partition of memory, and the second plurality of TSVs is communicatively coupled to a second partition of memory. In said embodiments, a first host device coupled to the dual-sided HBM device via a first IO circuit can access a first memory partition, and a second host device coupled to the dual-sided HBM device via a second IO circuit can access a second memory partition. In some embodiments, the first and second memory partitions are non-overlapping. In some embodiments, the memory of the dual-sided HBM device can be partitioned by bank, bank group, or pseudo channel.

The dual-sided HBM device provides additional advantages, such as expanding system architecture possibilities and facilitating heterogenous SiP designs (e.g., SiP devices with different types of host devices). As described above, a dual-sided HBM device may be part of a SiP device and used to communicate with multiple (e.g., two or more) host devices (e.g., GPUs, processors) using different IO interfaces. Furthermore, the different IO interfaces of the dual-sided HBM device can operate according to different protocols and standards, each of which may be best suitable for communicating with certain types of host devices. For example, one or more of the IO interfaces of the dual-sided HBM device can be configured to operate according to a JEDEC HBM DRAM standard. As a further example, one or more of the IO interfaces can be configured to operate according to a short reach interface standard, such as Universal Chiplet Interconnect Express (UCIe) or Peripheral Component Interconnect Express (PCIe). In some embodiments, for example, a first host device (e.g., a processor with memory controller) is communicatively coupled to a dual-sided HBM device via a first IO interface of the dual-sided HBM device, the first IO interface conforming to the JEDEC HBM DRAM standard, and a second host device (e.g., an Application Specific Integrated Circuit (ASIC)) is communicatively coupled to the dual-sided HBM device via a second IO interface of the dual-sided HBM device, the second IO interface conforming to a short reach interface standard (e.g., UCIe or PCIe). In some embodiments, all of the IO interfaces of a dual-sided HBM device conform to the JEDEC HBM DRAM standard. In other embodiments, all of the IO interfaces of a dual-sided HBM device conform to a short reach interface standard. In still other embodiments, the IO interfaces of a dual-sided HBM device are a mix of JEDEC HBM DRAM and short reach standard interfaces. In other words, the dual-sided HBM device enables bandwidth scaling by allowing multiple host devices of different types to access the dual-sided HBM device in a SiP device.

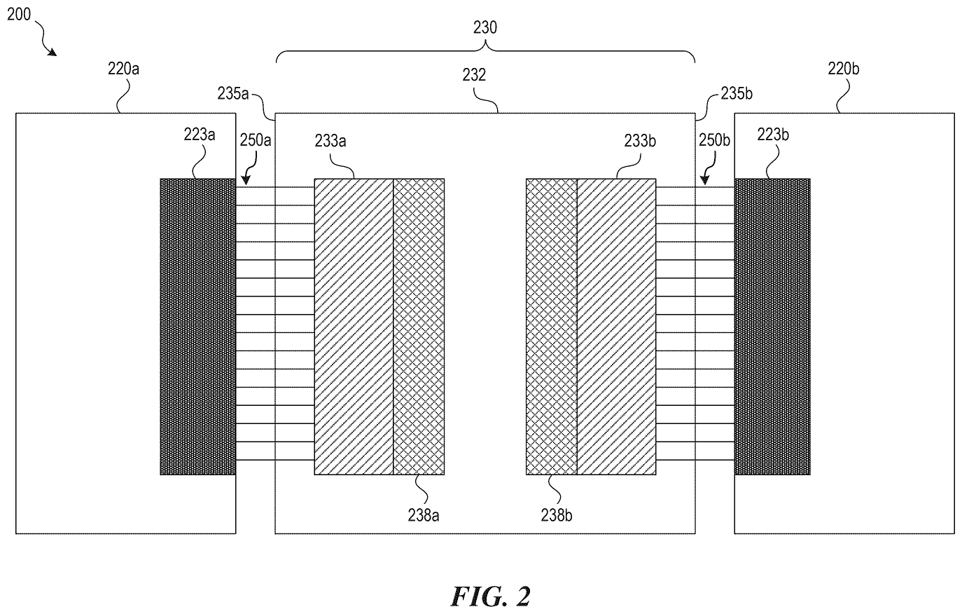

Additional details on the dual-sided SiP device, components thereof, and related systems and methods are discussed below with reference to FIGS. 2-5.

FIG. 2 is a partially schematic top-down view of a system-in-package device 200 configured in accordance with some embodiments of the present technology. In some embodiments, the SiP device 200 includes similar components and features as the SiP device 100 of FIG. 1. The SiP device 200 includes a dual-sided HBM device 230 communicably coupled to a plurality of host devices. For example, in some embodiments, the dual-sided HBM device 230 can be communicably coupled to first and second host devices 220a, 220b. In some embodiments, the dual-sided HBM device 230 is communicably coupled to more than two host devices. The dual-sided HBM device 230 is communicably coupled to the first and second host devices 220a, 220b via first and second IO circuits 233a, 233b, respectively. The first and second IO circuits 233a, 233b are disposed along first and second sides 235a, 235b, respectively, of an interface die 232. In some embodiments, the sides along which the IO circuits 233a, 233b are disposed are the sides nearest the host devices to which they are communicably coupled. In some embodiments, one or more of the IO circuits 233a, 233b are disposed on a side that is not nearest the host device to which it is communicably coupled. In some embodiments the host devices 220a and 220b include host IO circuits 223a and 223b, through which the host devices 220a and 220b are communicably coupled to the dual-sided HBM device 230. Further, the host IO circuits 223a, 223b are coupled to the dual-sided HBM device 230 IO circuits 233a, 233b via one or more communication channels 250a, 250b formed in a base substrate (e.g., the base substrate 110 of FIG. 1).

In some embodiments, the first and/or second IO circuits 233a, 233b are configured to operate according to a JEDEC HBM DRAM standard. In some embodiments, the first and/or second IO circuits 233a, 233b are configured to operate according to a short reach interface standard. For example, the first and second IO circuits 233a, 233b can be configured to operate according to a UCIe and/or PCIe standard. In some embodiments, the first and second IO circuits 233a, 233b are configured to operate according to different standards from each other. For example, the first IO circuit 233a can be configured to operate according to a JEDEC HBM DRAM standard, and the second IO circuit 233b can be configured to operate according to a short reach interface standard. As an additional example, the first IO circuit 233a can be configured to operate according to a UCIe standard, and the second IO circuit 233b can be configured to operate according to a PCIe standard.

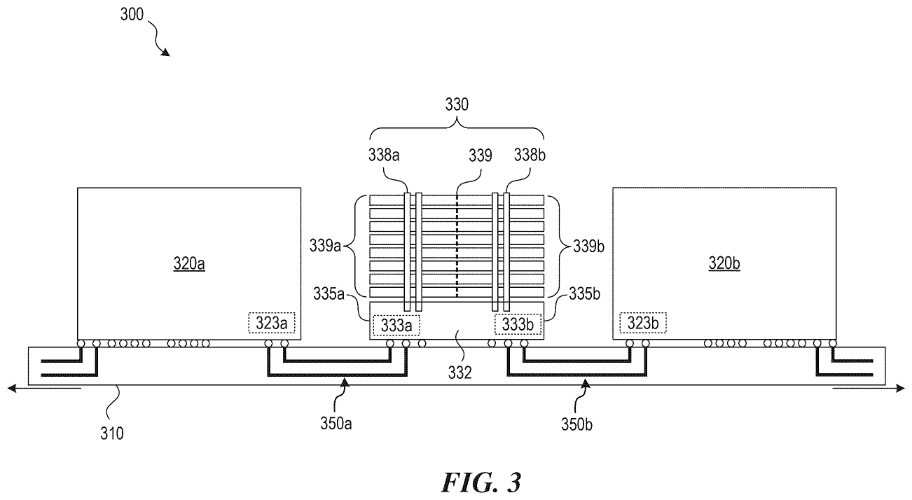

In some embodiments, the dual-sided HBM device 230 includes one or more TSVs. For example, FIG. 2 shows a first plurality of TSVs 238a, communicably coupling one or more memory dies (not shown) to the first IO circuit 233a disposed on the first side 235a of the interface die 232, and a second plurality of TSVs 238b communicably coupling the memory dies to the second IO circuit 233b disposed on the second side 235b of the interface die 232. In some embodiments, the first plurality of TSVs 238a coupled to the first IO circuit 233a can be utilized to respond to requests from the first host device 220a, and the second plurality of TSVs 238b coupled to the second IO circuit 233b can be utilized to respond to requests from the second host device 220b. In some embodiments, the first plurality of TSVs 238a can be used to respond to first host device 220a requests and access memory of the dual-sided HBM device 230 independently from the second plurality of TSVs 238b coupled to the second IO circuit 233b, and vice versa. In some embodiments, the memory of the dual-sided HBM device 230 is partitioned such that the first plurality of TSVs 238a is communicatively coupled to a first partition of memory, and the second plurality of TSVs 238b is communicatively coupled to a second partition of memory (discussed further in FIG. 3).

FIG. 3 is a partially schematic cross-sectional diagram of a system-in-package device 300 configured in accordance with some embodiments of the present technology. In some embodiments, the SiP device 300 includes similar components and features as the SiP device 200 of FIG. 2 and/or the SiP device 100 of FIG. 1. The SiP device 300 includes a dual-sided HBM device 330 communicably coupled to first and second host devices 320a, 320b via first and second IO circuits 333a, 333b, respectively. The first and second IO circuits 333a, 333b are disposed along first and second sides 335a, 335b, respectively, of an interface die 332. The host devices 320a and 320b include host IO circuits 323a and 323b, through which the first and second host devices 320a, 320b are communicably coupled to the dual-sided HBM device 330. The host IO circuits 323a, 323b are coupled to the dual-sided HBM device 330 IO circuits 333a, 333b via one or more communication channels 350a, 350b formed in a base substrate 310. In some embodiments the base substrate 310 is similar to the base substrate 110 discussed above with reference to FIG. 1. n some embodiments, the base substrate 310 is an interposer (e.g., a silicon interposer, another organic interposer, and/or an inorganic interposer).

As discussed above, in some embodiments, the dual-sided HBM device 330 includes two sets of TSVs (e.g., a first and second set of TSVs 338a, 338b) extending through the memory dies and coupled to the first and second IO circuits 333a, 333b, respectively, of the interface die 332. In some embodiments, the memory of the dual-sided HBM device 330 is partitioned such that the first plurality of TSVs 338a is communicatively coupled to a first partition of memory 339a, and the second plurality of TSVs 338b is communicatively coupled to a second partition of memory 339b, wherein the dashed line 339 represents a boundary between the first and second partitions of memory 339a, 339b. In said embodiments, the first host device 320a can access the first memory partition 339a of the dual-sided HBM device 330, and the second host device 320b can access the second memory partition 339b of the dual-sided HBM device 330. In some embodiments, the first and second memory partitions 339a, 339b are non-overlapping. In some embodiments, the memory of the dual-sided HBM device 330 can be partitioned by bank, bank group, or pseudo channel.

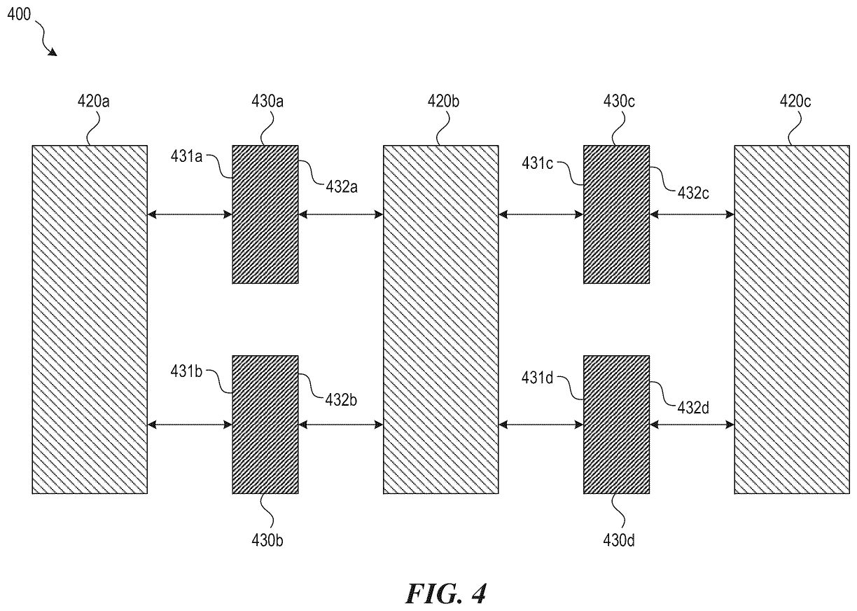

FIG. 4 is a partially schematic top-down view of a system-in-package device 400 configured in accordance with further embodiments of the present technology. In some embodiments the SiP device 400 includes similar components and features of any of the SiP devices of FIGS. 1-3. The SiP device 400 includes first, second, and third host devices 420a-c, and first, second, third, and fourth dual-sided HBM devices 430a-d, respectively. As illustrated in FIG. 4, each of the host devices is communicably coupled to a plurality of dual-sided HBM devices via IO circuits disposed on the nearest sides of the interface dies to each of the respective host devices. For example, first host device 420a is communicably coupled to first and second dual-sided HBM devices 430a and 430b via IO circuits disposed on sides 431a and 431b, and the second host device 420b is communicably coupled to the first, second, third, and fourth dual-sided HBM devices 430a-d via sides 432a, 432b, 431c, and 431d. In other words, as illustrated in FIG. 4, each dual-sided HBM device 430a-d is communicably coupled to two different host device, and (as discussed above) may respond independently and/or concurrently to requests from the different host devices.

In some embodiments, each of the host devices 420a-c (e.g., processors with memory controllers) are communicatively coupled to one or more dual-sided HBM devices 430a-d via corresponding IO interface circuits conforming to a JEDEC HBM DRAM standard. In some embodiments, each of the host devices 420a-c (e.g., Application Specific Integrated Circuits (ASICs)) are communicatively coupled to one or more dual-sided HBM device 430a-d corresponding IO circuits conforming to a short reach interface standard (e.g., UCIe or PCIe). In some embodiments, the host devices 420a-c are communicably coupled to one or more dual sided HBM devices 430a-d via corresponding IO circuits conforming to a mix of JEDEC HBM DRAM and short reach interface standards. In other words, each dual-sided HBM device 430a-d may be communicably coupled to different host devices via IO interfaces conforming to different standards. For example, the first host device 420a can be communicably coupled to the first and second HBM devices 430a, 430b via corresponding IO circuits conforming to the JEDEC HBM DRAM standard, while the second host device 420b can be communicably coupled to the first and second HBM devices 430a, 430b via corresponding IO circuits conforming to the short reach interface standard.

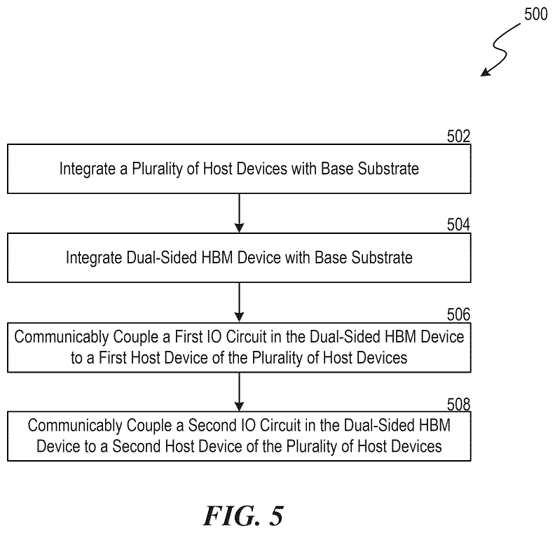

FIG. 5 is a flow diagram of a process 500 for manufacturing a system-in-package device in accordance with some embodiments of the present technology. The process 500 can be implemented by a single manufacturing apparatus and/or split between multiple manufacturing apparatuses to construct SiP devices according to the embodiments discussed above.

The process 500 begins at block 502 by integrating a plurality of host devices with a base substrate of the SiP device. In various embodiments, the base substrate can be a silicon interposer, a substrate of organic material, a substrate of inorganic material, and/or any other suitable material that provides external connections to the host device and/or provides mechanical support for the components of a SiP device. Integrating the plurality of host devices with the base substrate can include bonding the host devices to the base substrate via one or more interconnect structures (e.g., solder structures, conductive posts, and/or the like) and/or forming one or more metal-metal bonds directly between bond pads in the base substrate and bond pads in each of the plurality of host devices.

At block 504, the process 500 includes integrating a dual-sided HBM device with the base substrate. Similar to the discussion above, integrating the dual-sided HBM device with the base substrate can include bonding the dual-sided HBM device to the base substrate via one or more interconnect structures and/or forming one or more metal-metal bonds directly between bond pads in the base substrate and bond pads in the dual-sided HBM device. In some embodiments, the process 500 can execute block 504 before executing all (or some of) block 502 to integrate the dual-sided HBM device with the base substrate before integrating one or more of the plurality of host devices with the base substrate. In some embodiments, the process 500 can execute block 504 at generally the same time as block 502 to integrate the host devices and the dual-sided HBM device with the base substrate at generally the same time.

At block 506, the process 500 includes communicably coupling a first IO circuit in the dual-sided HBM device (e.g., the IO circuit 333a in the interface die 332 of FIG. 3) to a first host device (e.g., to the host IO circuit 323a of FIG. 3) of the plurality of host devices. As discussed in more detail above, the communicable coupling can be accomplished through one or more communication channels in an upper surface of the base substrate. In some embodiments, the first IO circuit is disposed on a first side of the interface die. In some embodiments, the first side of the interface die is the side closest to the first host device. In alternative embodiments, the first side of the interface die is not the side closest to the first host device.

At block 508, the process 500 includes communicably coupling a second IO circuit in the dual-sided HBM device (e.g., the IO circuit 333b in the interface die 332 of FIG. 3) to a second host device (e.g., to the host IO circuit 323b of FIG. 3) of the plurality of host devices. The communicable coupling can be accomplished through one or more communication channels in an upper surface of the base substrate. In some embodiments, the second IO circuit is disposed on a second side of the interface die. In some embodiments, the second side of the interface die is the side opposite the first side of the interface die. In some embodiments the second side of the interface die is the side closest to the second host device. In some embodiments, both of the first and second host devices of the plurality of host devices are communicably coupled to the dual-sided HBM device via IO circuits disposed on sides of the interface die nearest the coupled host devices. In some embodiments, the first and second IO circuits of the dual-sided HBM device are not disposed on the sides of the interface die nearest the first and second host devices, respectively.

In some embodiments, the first and second IO circuits of the dual-sided HBM device can operate according to different protocols and standards (e.g., a JEDEC HBM DRAM and/or short reach interface standard) to accommodate different types of host devices in the SiP device. For example, in some embodiments, the first IO circuit can be configured to operate according to a JEDEC HBM DRAM standard, while the second IO circuit can be configured to operate according to a short reach interface standard (e.g., UCIe or PCIe). In some embodiments, the first and second IO circuits of the dual-sided HBM device conform to the JEDEC HBM DRAM standard. In other embodiments, the first and second IO circuits conform to a short reach interface standard.

In some embodiments, the dual-sided HBM device can also include two sets of through substrate vias (TSVs) extending through the memory dies and coupled to the first and second IO circuits of the interface die. For example, a first plurality of TSVs can extend couple to the first IO circuit of the first side of the interface die, and a second plurality of TSVs can couple to the second IO circuit of the second side of the interface die. In some embodiments, the first plurality of TSVs communicably coupled to the first host device can be used to respond to requests from the first host device and access memory of the dual-sided HBM device independent of the second plurality of TSVs communicably coupled to the second host device, and vice versa. In some embodiments, the memory of the dual-sided HBM device is partitioned such that the first plurality of TSVs is communicatively coupled to a first partition of memory, and the second plurality of TSVs is communicatively coupled to a second partition of memory. In said embodiments, the first host device can access a first memory partition of the dual-sided HBM device, and the second host device can access a second memory partition of the dual-sided HBM device. In some embodiments, the first and second memory partitions are non-overlapping. In some embodiments, the memory of the dual-sided HBM device can be partitioned by bank, bank group, or pseudo channel.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately,” “generally,” and/or “about” are used herein to mean within at least 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A system-in-package (SiP) device, comprising:
a base substrate;
a high-bandwidth memory (HBM) device carried by the base substrate, wherein the HBM device comprises:
an interface die comprising a first input/output (IO) interface disposed on a first side of the interface die, and second IO interface disposed on a second side of the interface die;
one or more volatile memory dies carried by the interface die; and
an HBM bus communicatively coupled to the interface die and each of the one or more volatile memory dies;
a first host device carried by the base substrate adjacent to the first side of the interface die, wherein the first host device is communicatively coupled to the HBM device by the first IO interface; and
a second host device carried by the base substrate adjacent to the second side of the interface die, wherein the second host device is communicatively coupled to the HBM device by the second IO interface.

2. The SiP device of claim 1, wherein the HBM bus comprises:
a first plurality of through substrate vias (TSVs) extending through the one or more volatile memory dies and coupled to the first IO interface of the interface die; and
a second plurality of TSVs extending through the one or more volatile memory dies and coupled to the second IO interface of the interface die.

3. The SiP device of claim 2, wherein each volatile memory die of the one or more volatile memory dies comprises a first memory partition and a second memory partition, wherein the first memory partition of the one or more memory dies is coupled to the first plurality of TSVs, and the second memory partition of the one or more memory dies is coupled to the second plurality of TSVs.

4. The SiP device of claim 3, wherein the first partition is associated with a first set of memory banks and the second partition is associated with a second set of memory banks.

5. The SiP device of claim 3, wherein the first partition is associated with a first plurality of bank groups, and the second partition is associated with a second plurality of bank groups.

6. The SiP device of claim 3, wherein the first partition is associated with a first pseudo channel, and the second partition is associated with a second pseudo channel.

7. The SiP device of claim 1, wherein the first host device is coupled to the first IO interface through a first SiP bus, and the second host device is coupled to the second IO interface through a second SiP bus.

8. The SiP device of claim 1, wherein at least one of the first IO interface or the second IO interface is configured to operate in accordance with a JEDEC HBM DRAM standard.

9. The SiP device of claim 1, wherein at least one of the first IO interface or the second IO interface is configured to operate in accordance with a short reach interface standard.

10. The SiP device of claim 1, wherein the first IO interface is configured to operate in accordance with a JEDEC HBM DRAM standard and the second IO interface is configured to operate in accordance with a short reach interface standard.

11. The SiP device of claim 9, wherein the short reach interface is Universal Chiplet Interconnect Express (UCIe).

12. The SiP device of claim 9, wherein the short reach interface is Peripheral Component Interconnect Express (PCIe).

13. A high-bandwidth memory (HBM) device, comprising:
a die stack having a plurality of memory dies, wherein the die stack comprises a first portion of memory and a second portion of memory;
an interface die carrying the die stack, wherein the interface comprises a first input/output (IO) interface and a second IO interface;
a first plurality of through substrate vias (TSVs) coupled to the first IO interface and each of the memory dies of the die stack; and
a second plurality of TSVs coupled to the second IO interface and each of the memory dies of the die stack.

14. The HBM device of claim 13, wherein the first IO interface is configured to communicate with a first host device, and the second IO interface is configured to communicate with a second host device.

15. The HBM device of claim 14, wherein the first IO interface and second IO interface are independent interfaces.

16. The HBM device of claim 13, wherein the first plurality of TSVs is coupled to the first portion of memory of the die stack, and the second plurality of TSVs is coupled to the second portion of memory of the die stack.

17. The HBM device of claim 13, wherein the first portion of memory of the die stack is associated with a first set of memory banks and the second portion of memory of the die stack is associated with a second set of memory banks.

18. The HBM device of claim 13, wherein the first portion of memory of the die stack is associated with a first pseudo channel, and the second portion of memory of the die stack is associated with a second pseudo channel.

19. The HBM device of claim 13, wherein at least one of the first IO interface or the second IO interface is configured to operate in accordance with a JEDEC HBM DRAM standard.

20. The HBM device of claim 13, wherein at least one of the first IO interface or the second IO interface is configured to operate in accordance with a short reach interface standard.
